(19) United States
(12) Patent Application Publication
(10) Pub. No.: US 2021/0272318 A1
(43) Pub. Date: Sep. 2, 2021

(54) IDENTIFIED OBJECT BASED IMAGING SCANNER OPTIMIZATION

(71) Applicant: ZEBRA TECHNOLOGIES CORPORATION, Lincolnshire, IL (US)

(72) Inventor: Thomas Conticello, Saint James, NY (US)

(21) Appl. No.: 16/805,089

(22) Filed: Feb. 28, 2020

(51) Int. Cl. G06T 7/80; G06N 3/08; G06N 3/04; G06K 7/14

(52) U.S. Cl. CPC G06T 7/80; G06N 3/08; G06N 3/04; G06T 2207/10152; G06T 2207/20081; G06T 2207/20084; G06K 7/1413

(57) ABSTRACT

Methods and systems for performing contextual configuration of an imaging scanner are disclosed. An example method includes an imaging scanner capturing an image of an object and providing the image to a trained neural network for classification. Configuration settings corresponding to the particular classification are determined, where those configuration settings are for operating the imaging scanner and are contextual to the object being scanned. The imaging scanner is configured based on the configuration settings, and the object is re-scanned under optimal configuration, for improved barcode reading or defect detection for machine vision systems.

### BACKGROUND

Imaging-based scanners may be configured for optimized performance for different types of objects, such as mobile phone displays, reflective surfaces, curved surfaces, object type, etc. However, in mixed use case environments, reconfiguring the imaging-based scanner is cumbersome and error prone. The operator must adjust scanner parameters manually, for example, through pushbuttons on the scanner, menu screens, or other software means. There is a need for improved and automated scanner optimization techniques.

### SUMMARY

In an embodiment, the present invention is a computer-implemented method for performing contextual configuration of an imaging scanner. The method comprises a) identifying, at the imaging scanner, an image of an object; b) providing the image to a trained neural network and the trained neural network classifying the object; c) determining configuration settings for the imaging scanner based on classification of the object; and d) configuring the imaging scanner to scan for an indicia using the configuration settings.

In a variation of this embodiment, the configuration settings are optical settings for the imaging scanner. In some examples, the optical settings include illumination source, illumination brightness, exposure time, optical gain, indirect illumination source, direct illumination source, illumination color, and/or illumination source type.

In another variation of this embodiment, the configuration settings are digital imaging settings for the imaging scanner, which may be digital gain, in some examples.

In another variation of this embodiment, the configuration settings are physical settings for the imaging scanner, where in some examples these physical settings include focal distance, field of view, and focal plane position of an imaging sensor.

In another variation of this embodiment, the trained neural network is a convolutional neural network. In various examples, the trained neural network is trained to classify objects by object type, scanning surface of the object, reflectivity of the object, and/or type of indicia on object.

In another variation of this embodiment, the trained neural network classifying the object includes the trained neural network providing a plurality of classifications of the object. In some embodiments, the method includes; identifying a highest priority classification from the plurality of classifications; assigning the object the highest priority classifications; and determining the configuration settings for the imaging scanner based on the highest priority classification.

In another embodiment, an imaging scanner comprises: an imager assembly configured to capture an image of an object; and a processor and memory storing instructions that, when executed, cause the processor to: identify an image of an object; provide the image to a trained neural network and classify, using the trained neural network, the object; determine configuration settings for the imaging scanner based on classification of the object; and configure the imaging scanner to scan for an indicia using the configuration settings.

In a variation of this embodiment, the memory stores further instructions that, when executed, cause the processor to: determine the configuration settings for the imaging scanner based on the classification of the object by selecting from a plurality of configuration settings stored on the imaging scanner.

In a variation of this embodiment, the memory stores further instructions that, when executed, cause the processor to: using the trained neural network, classify the object to have a plurality of classifications of the object; identify a highest priority classification from the plurality of classifications; assign the object the highest priority classifications; and determine the configuration settings for the imaging scanner based on the highest priority classification.

In a variation of this embodiment, the imaging scanner is a barcode reader.

In a variation of this embodiment, the imaging scanner is a machine vision system.

In a variation of this embodiment, the configuration settings are optical settings for the imaging scanner. In some examples, the optical settings include illumination source, illumination brightness, exposure time, optical gain, indirect illumination source, direct illumination source, illumination color, and/or illumination source type.

In another variation of this embodiment, the configuration settings are digital imaging settings for the imaging scanner, which may be digital gain, in some examples.

In another variation of this embodiment, the configuration settings are physical settings for the imaging scanner, where in some examples these physical settings include focal distance, field of view, and focal plane position of an imaging sensor.

In another variation of this embodiment, the trained neural network is a convolutional neural network. In various examples, the trained neural network is trained to classify objects by object type, scanning surface of the object, reflectivity of the object, and/or type of indicia on object.

In another variation of this embodiment, the trained neural network classifying the object includes the trained neural network providing a plurality of classifications of the object. In some embodiments, the memory stores further instructions that, when executed, cause the processor to: identify a highest priority classification from the plurality of classifications; assign the object the highest priority classifications; and determine the configuration settings for the imaging scanner based on the highest priority classification.

In a variation of this embodiment, the memory stores further instructions that, when executed, cause the processor to: identify the image of the object as a captured image of the object, captured by the imaging scanner.

In a variation of this embodiment, the memory stores further instructions that, when executed, cause the processor to: identify the image of the object as a lower resolution rendition of a captured image of the object.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example imaging scanner for implementing example methods and/or operations described herein including techniques for performing contextual configurations of an imaging scanner.

FIG. 2 illustrates a block diagram of an example logic circuit for a classification system having a scanning station with an imaging scanner and a classification server for implementing example methods and/or operations described herein including techniques for performing contextual configurations of an imaging scanner.

FIG. 3 illustrates is a block diagram of an example process as may be implemented by the classification system of FIG. 2, for implementing example methods and/or operations described herein including techniques for performing contextual configurations of an imaging scanner.

FIG. 4 illustrates is a block diagram of an example process for determining contextual configuration settings for an imaging scanner as may be implemented by the classification system of FIG. 2, for implementing example methods and/or operations described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In various embodiments of the present disclosure, a method, and related systems and devices, are described for performing contextual configurations of an imaging scanner.

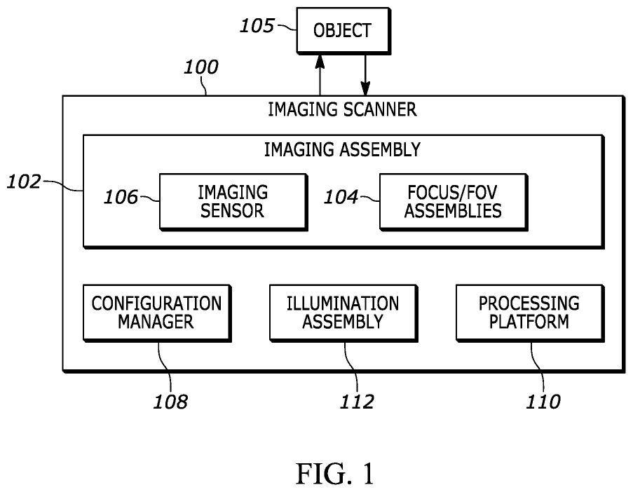

FIG. 1 is an illustration of an example imaging scanner 100 capable of implementing operations of the example methods described herein, as may be represented by the flowcharts of the drawings that accompany this description.

As discussed in various examples, the imaging scanner 100 may be a barcode reader, such as a handheld barcode reader or mountable barcode reader, capable of reading a barcode on an object in the field of view of the barcode reader.

In some examples, the imaging scanner 100 may be a barcode reader formed as an imager, such as bi-optic imager having of a vertical extending platter and horizontal extending tower, each capable of capturing an image of an object over a field of view, and each capable of identifying and reading a barcode on the object. As used herein, reference to barcode includes any indicia that contains decodable information and that may be presented on or within a target, including by not limited to, a one dimension (1D) barcode, a two dimension (2D) barcode, a three dimension (3D) barcode, a four dimension (4D) barcode, a QR code, a direct part marking (DPM), etc.

In various other examples, the imaging scanner 100 may be a machine vision system, i.e., an automated imaging-based inspection and analysis system used for such applications as part inspection, process control, and robot guidance, usually in industry.

In the illustrated example, the imaging scanner 100 includes an imaging assembly 102 configured to capture an image of a target. To focus on objects of interest, the example imaging assembly 102 includes any number and/or type(s) of focus/field-of-view assemblies (focus/FOV assemblies) 104 that collect reflected light from an object 105 and impinge that light onto an imaging sensor 106. These focus/FOV assemblies 104 may be formed of a different fields of views, each collecting a different field of view of a space. These focus/FOV assemblies 104 may be characterized by one or more focal distances and one or more focal plane positions of the imaging sensor 106. In various examples, one or more of these physical features of the focus/FOV assemblies may be controllable by configuring these physical settings using a configuration manager 108 discussed further below.

In a barcode reader implementation of the imaging scanner 100, for example, these focus/FOV assemblies 104 may include a variable focusing element, either an optically controllable variable focusing element or a digitally controllable variable focusing element. A barcode reader may include other systems having physical features that may be configured by the configuration manager 108. For example, a barcode reader implementation may further include an aiming assembly configured to generate an aiming pattern, e.g., dot, crosshairs, line, rectangle, circle, etc., that impinges on the target.

The imaging scanner 100 may have a number of other configurable physical systems. For example, in machine vision implementations and in some barcode reader implementations, the focus/FOV assemblies 104 may include variable focus elements positioned between the imaging sensor 106 and a housing window (not shown), and any number and/or type(s) of actuators to activate, operate, etc. the variable focus elements under the control of a processing platform 110, which may access the configuration manager 108. Example variable focus elements include, but are not limited to, a liquid lens, a voice coil motor, etc. Example actuators include a focusing lens drive, a shift lens drive, a zoom lens drive, an aperture drive, angular velocity drive, voice coil motor drive, etc.

In the illustrated example, the processing platform 110 may access the configuration manager 108, storing different configuration settings for operating any of the systems in the imaging assembly 102. For example, the processing platform 110 may set one or more focus parameters for variable focus elements used for capture reflect light or used for transmitting illumination light. In this manner, the processing platform 110 can control the focus distance to an imaging plane of the imaging sensor 106 to an intended or needed focus distance, e.g., through contextual configuration settings in accordance with the techniques herein.

In some examples, in particular in machine vision implementations, the focus/FOV assemblies 104 may have an autofocus module or autofocus operation, where that the autofocus operation is configurable (e.g., through contextual configuration settings in accordance with the techniques herein) to be disabled for at least one image capture operation and where focus distance is controlled by the processing platform 110 via configuration settings for fixed focus image capture operation in place of autofocus operation.

The imaging scanner 100 further includes an illumination assembly 112 configured to illuminate a target over one or more fields of view the imaging scanner 100.

In a barcode reader implementation, for example, the illumination assembly 112 may generate a monochromatic illumination over a field of view, while in other examples, the illumination assembly 112 generates a poly-chromatic illumination, such a white light illumination, over the field of view. In various examples, the illumination assembly 112 contains a plurality of different illumination sources, such as illumination sources that generate illumination at different output wavelengths. In some examples, these illumination sources differ in type, such that the illumination assembly 112 may include light emitting diodes (LEDs), visible light sources, and/or infrared light sources. Which illumination source is being used at a given time may be determined by the processing platform 110 accessing the configuration manager 108, for example, i.e., through configuration settings in accordance with the techniques herein.

In some examples, the illumination assembly 112 is a tunable illumination source, where the output wavelength(s) of the illumination is determined by the processing platform 110 accessing the configuration manager 108, i.e., through contextual configuration settings in accordance with the techniques herein. In some examples, the illumination source may be a direct illumination source. In some examples, the illumination source may be an indirect illumination source.

In these ways, the illumination assembly 112 includes numerous configurable settings, including the selected illumination source, the illumination wavelength or wavelength range, the type of illumination source, and the illumination brightness. These features may be configured by instruction from the processing platform 110 accessing the configuration manager 108. Attendantly, optical features of the imaging sensor 106 may be configured, such as optical gain and exposure time, where optical gain refers to controlling optical gain elements in the path of the received light. In other examples, digital gain, for example, as applied in the readout integrated circuit of the imaging sensor 106, may be configured.

Further, in some examples, the illumination assembly 112 may have one or more fields of view for different illumination sources, such as, a bi-optic imager having a horizontal tower illumination assembly for producing an illumination beam extending vertically into a first field of view and a vertical platter illumination assembly for producing an illumination beam extending horizontally into a second field of view, where these two fields of view can overlap. The field of view currently used by the illumination assembly 112 may be selected and, in some examples, adjusted, through configuration settings.

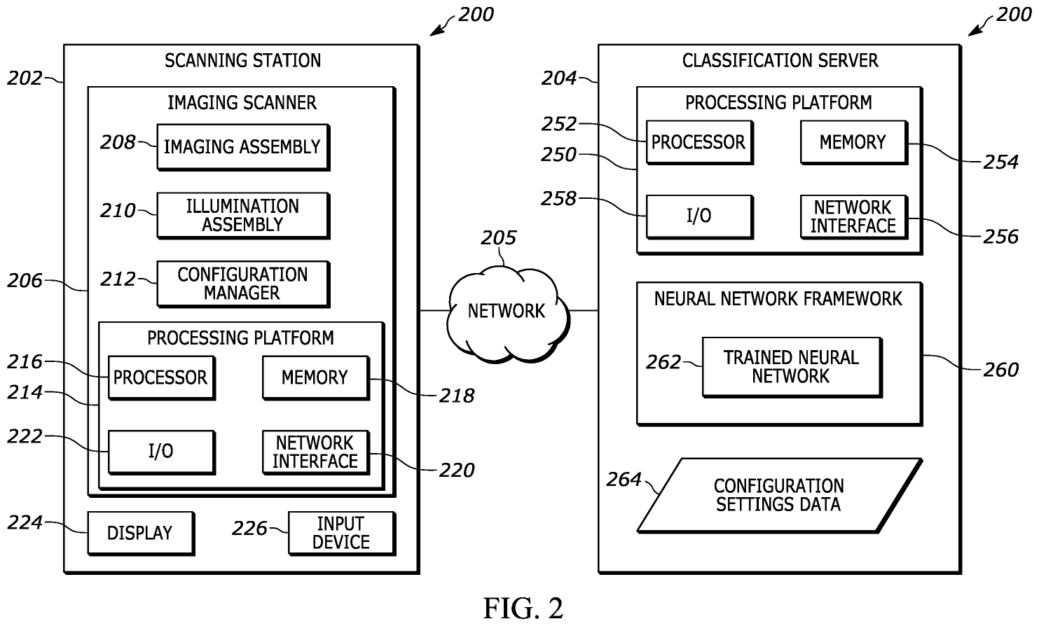

FIG. 2 illustrates a classification system 200 having a scanning station 202, such as a POS scanning station or machine vision scanning station, and classification server 204, coupled together by an external wireless network 205. The scanning station 202 includes an imaging scanner 206, which may implement the imaging scanner 100 of FIG. 1. For example, the imaging scanner 206 may include an imaging assembly 208, an illumination assembly 210, and a configuration manager 212. The imaging scanner 206 further includes a processing platform 214 capable of executing instructions to, for example, implement operations of the example methods described herein, as may be represented by the flowcharts of the drawings that accompany this description. That is, the example logic circuit of FIG. 1 may be implemented through the processing platform 214. Other example logic circuits capable of, for example, implementing operations of the example methods described herein include field programmable gate arrays (FPGAs) and application specific integrated circuits (ASICs). The processing platform 214 is illustrated by way of example. In some examples, the processing platform 214 is implemented in the scanning station 202 and interfaces with a similar processing platform within the imaging scanner 206, such as the processing platform 110 shown in FIG. 1. In some examples, the processing platform 214 may be implemented partially within the imaging scanner 206.

The example processing platform 214 of FIG. 2 includes a processor 216 such as, for example, one or more microprocessors, controllers, and/or any suitable type of processor. The example processing platform 214 includes memory (e.g., volatile memory, non-volatile memory) 218 accessible by the processor 216 (e.g., via a memory controller). The example processor 216 interacts with the memory 218 to obtain, for example, machine-readable instructions stored in the memory 218 corresponding to, for example, the operations represented by the flowcharts of this disclosure. Additionally or alternatively, machine-readable instructions corresponding to the example operations described herein may be stored on one or more removable media (e.g., a compact disc, a digital versatile disc, removable flash memory, etc.) that may be coupled to the processing platform 214 to provide access to the machine-readable instructions stored thereon.

The example processing platform 214 of FIG. 2 also includes a network interface 220 to enable communication with other machines via, for example, one or more networks, including the classification server 204 via the network 205. The example network interface 220 includes any suitable type of communication interface(s) (e.g., wired and/or wireless interfaces) configured to operate in accordance with any suitable protocol(s).

The example, processing platform 214 also includes input/output (I/O) interfaces 222 to enable receipt of user input and communication of output data to the user.

While note shown, in various example implementations, imaging scanner 206 may include other systems, such as an image processor and indicia decoder. The imaging scanner 206 may further include additional sensors, such as an RFID transponder for capturing indicia data is the form of an electromagnetic signal captured from an RFID tag associated with an object. These additional sensors may be configured using contextual configuration settings in accordance with the techniques herein. As shown, the scanning station 202 may further include a digital display 224 and an input device 226, such as a keypad, for receiving input data from a user.

The classification server 204 is configured to execute computer instructions to perform operations associated with the systems and methods as described herein, including contextual configuration settings in accordance with the techniques herein. The classification server 204 may implement enterprise service software that may include, for example, RESTful (representational state transfer) API services, message queuing service, and event services that may be provided by various platforms or specifications, such as the J2EE specification implemented by any one of the Oracle WebLogic Server platform, the JBoss platform, or the IBM WebSphere platform, etc. Other technologies or platforms, such as Ruby on Rails, Microsoft .NET, or similar may also be used.

The classification server 204 includes an example logic circuit in the form processing platform 250 capable of, for example, implementing operations of the example methods described herein include. Other example logic circuits capable of, for example, implementing operations of the example methods described herein include field programmable gate arrays (FPGAs) and application specific integrated circuits (ASICs). The processing platform 250 includes a processor 252 such as, for example, one or more microprocessors, controllers, and/or any suitable type of processor. The example processing platform 250 includes memory (e.g., volatile memory, non-volatile memory) 254 accessible by the processor 252 (e.g., via a memory controller). The example processor 252 interacts with the memory 254 to obtain, for example, machine-readable instructions stored in the memory 254 corresponding to, for example, the operations represented by the flowcharts of this disclosure. Additionally or alternatively, machine-readable instructions corresponding to the example operations described herein may be stored on one or more removable media (e.g., a compact disc, a digital versatile disc, removable flash memory, etc.) that may be coupled to the processing platform 250 to provide access to the machine-readable instructions stored thereon.

The example processing platform 250 also includes a network interface 256 to enable communication with other machines via, for example, one or more networks, including the scanning station 202. The example network interface 256 includes any suitable type of communication interface(s) (e.g., wired and/or wireless interfaces) configured to operate in accordance with any suitable protocol(s).

The example, processing platform 250 also includes input/output (I/O) interfaces 258 to enable receipt of user input and communication of output data to the user.

The classification server 204 includes a neural network framework 260 configured to develop a trained neural network 262 and to use that trained neural network to receive images captured by the imaging scanner 206, identify objects within the received images, and classify those objects. The neural network framework 260, for example, may be configured as a convolutional neural network employing a multiple layer classifier to assess identified image features and generate classifiers for the trained neural network 262.

To set and/or adjust various configuration parameters of the imaging scanner 206, the trained neural network 262 may be trained to classify objects in received image data by object type, scanning surface of the object, whether the object is a display screen such as a mobile device display, reflectivity of the object, and/or type of indicia on object.

In these ways, through the framework 260 and the trained neural network 262, in various examples, the present techniques deploy one or more trained prediction models to assess received images of an object (with or without indicia) and classify those images to determine an object and object classification, for identifying contextual configuration settings to use in operating the imaging scanner 206 or other imaging devices.

From the determined classifications, in various examples, the present techniques use an object's classification to determine adjustments for configuration settings of the imaging scanner. That is, a prediction model is trained using a neural network, and as such that prediction model is referred to herein as a “neural network” or “trained neural network.” The neural network herein may be configured in a variety of ways. In some examples, the neural network may be a deep neural network and/or a convolutional neural network (CNN). In some examples, the neural network may be a distributed and scalable neural network. The neural network may be customized in a variety of manners, including providing a specific top layer such as but not limited to a logistics regression top layer. A convolutional neural network can be considered as a neural network that contains sets of nodes with tied parameters. A deep convolutional neural network can be considered as having a stacked structure with a plurality of layers. In examples herein, the neural network is described as having multiple layers, i.e., multiple stacked layers, however any suitable configuration of neural network may be used.

CNNs, for example, are a machine learning type of predictive model that are particularly using for image recognition and classification. In the exemplary embodiments herein, for example, CNNs can operate on 2D or 3D images, where, for example, such images are represented as a matrix of pixel values within the image scan data. As described, the neural network (e.g., the CNNs) can be used to determine one or more classifications for a given image by passing the image through the series of computational operational layers. By training and utilizing theses various layers, the CNN model can determine a probability that an image (or object(s) within an image) or physical image features belongs to a particular class. Trained CNN models can be persisted for restoration and use, and refined by further training. Trained models can reside on any in-premise computer volatile or non-volatile storage mediums such as RAM, flash storage, hard disk or similar storage hosted on cloud servers.

In various examples, the system 200 is configured to adjust parameters of the imaging scanner 206 based on detectable features of an imaged object. Instead of the scanning station 202 requiring pre-configuration to optimally image an object, with the present techniques, configuration settings are contextual, based on the object being imaged and based on the conditions under which the object is being imaged. In some imaging examples, an object's color or shape or position in a field of view can affect how the object is imaged, the quality of that image, the size of the object in the image, the size of indicia or other identifiable portions of the object, the reflections off the object that obscure some portion of the object, the background around the object, or the contrast of the object against that background. In some examples, the object is a display screen, such as a mobile device screen bearing a barcode to be scanned. Each of these contextual elements and many others can affect the quality of images capture for an object, and in some instances these contextual elements can affect an imaging scanner ability to read an indicia on the object, in the case of a barcode reader, or the affect the ability to detect defects in an object, in the case of a machine vision system.

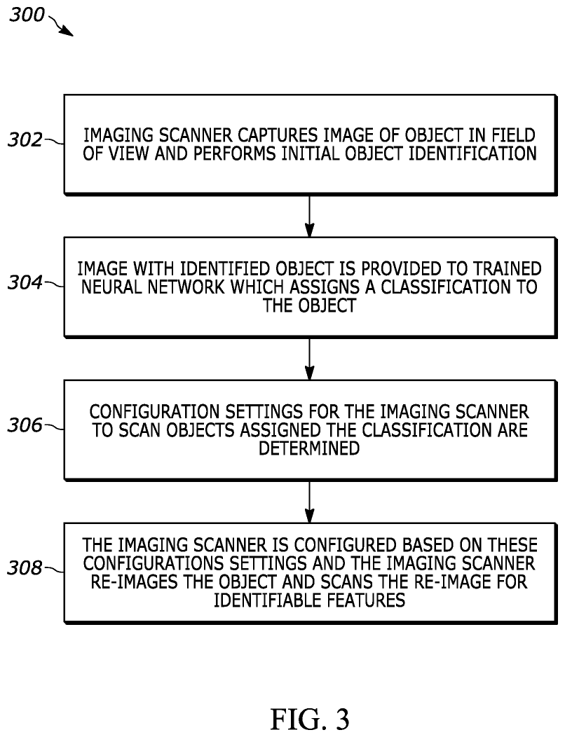

To perform contextual configuration of the imaging scanner, images captured by the imaging scanner 206 are communicated to the classification server 204. FIG. 3 shows an example process 300 for contextual configuration setting that may then be executed to configure the imaging scanner 206, as a result. In some examples, including those described below, the process 300 may be performed across the scanning station 202 and the classification server 204. In other examples, however, the process 300 may be performed entirely at the scanning station 202. In some such examples, the classification server 204 is implemented a classification processing system on the scanning station 202, where the neural network framework, trained neural network, and configuration settings are all implemented on the scanning station 202.

At a process 302, the imaging scanner 206 captures one or more images of an object in one or more fields of view. In some examples, the imaging assembly 208 performs initial processing on the image(s) to identify the object of interest in the image, where that initial processing may include performing an object localization process, an object detection process, and an object segmentation process. For example, the process 302 may identify one or more borders of the object and segment the object from the background portion of the image. The image with the segmented object data is then transmitted to the classification server 204 over the network 205.

In some examples, the imaging scanner 206 may capture a lower resolution image of the object for classification, i.e., where the resolution is lower than typically would be captured by the imaging scanner for ordinary object identification purposes used in point of sale implementations, machine vision implementations, etc. The process 302 may assess the received image data, determine that the image is a lower resolution image, and perform initial object identification on that lower resolution image, for example, by applying a less rigid set of image processing rules to localize the object, detect the object, and segment the object. In some examples, for example, the process 302 may perform only object localization and detection, without identifying borders for segmentation purposes. In any event, this lower image with the object data may be communicated to the process 304.

These initial processing examples, albeit optional, may allow for faster classification of the object at the server. In other examples, object identification may be performed entirely (or partially) at the classification server 204. Such operations may be desirable in implementations in which the classification server 204 is updated on a more frequent basis, e.g., through continuing training of the deep learning framework therein, compared to updating of the scanning station 202. Such operations may be desirable because typically the classification server 204 is a more powerful processing system. Such operations may be desirable to reduce data traffic loads on the network 205 and on the classification server 204.

To assign a classification to the identified object, at process 304, the classification server 204 receives the image with identified object and provides that data the deep learning framework 260, in particular to the trained neural network 262 within that framework. The trained neural network 262 assigns a classification to the object, at process 304 as well. The trained neural network 262, as noted above, may be trained to classify a number of different objects. The trained classifications may include classifying objects by object type, for example whether the object is produce or package, the type of produce, the type of package, the type of product or products within the package, whether the product or products are high cost items or lower cost items, etc. The trained classifications may further include classifiers identifying the scanning surface of the object, such as the front face of the object, the face of the object bearing an indicia or other identifiable feature, whether the surface is flat or whether the surface is curved. The trained classifications may further classify the reflectivity of the object, such as whether the object exhibits a bright spot reflection from a light source, such as that of the illumination assembly 210. The trained classifications may include whether the object being scanned is itself a display screen or is on a display screen, such as a mobile device display screen. The trained classifications may further classify the type of identifiable feature on the object. For example the trained classifications may identify and classify an indicia on the object, i.e., on a surface of the object. The trained classifications may identify the type of indicia as a 1D or 2D barcode, a QR code, or other indicia (collectively these are all referred to “barcodes” herein). These identifiable features are in the context of barcode scanner implementations. The trained classifications may identify the identifiable features as features on an object to be examined for quality assessment in machine vision applications. In such implementations, the identifiable features may be surfaces of an object to be examined, open fittings in a surface such as open screw holes, edges of a surface, for example to later assess the straightness of the edges.

At a process 306, the classification of the object from the trained neural network 262 is used to determine configuration settings for the imaging scanner 206, and at the process 308 the imaging scanner is configured based on these configurations settings, after which the imaging scanner re-images the object and scans that re-image for identifiable features.

The process 306 may be implemented at the classification serer 204, for example, by the processing platform 250 accessing configuration settings data 264 stored in the classification server 204. The configuration settings data 264 may be a data file that contains different object classifications and predetermined configuration settings for the different classifications, where, in some examples, different classifications may have different types of configuration settings assigned thereto. For example, classifications related to object surface reflectivity may have corresponding configuration settings for the illumination assembly 210, configuration settings for instructing the illumination assembly to use a lower illumination intensity. In another example, a classification that the object has curved surface may correspond to configuration settings to use an indirect illumination source, such as configuring a bi-optic imaging scanner to illuminate an object using either a vertical platter assembly or a horizontal tower assembly and imaging the object through the other.

In some examples, the process 306 is implemented partially between the classification server 204 and the scanning station 202. In some examples, the process 306 is implemented entirely at the scanning station 202. Indeed, any of the processes of FIG. 3 may be implemented entirely on the scanning station 202. For example, in some examples, the configuration manager 212 may include the aforementioned features of the classification server, such as the neural network framework, trained neural network, and configuration settings. In some examples, the configuration manager 212 is configured to include a trained neural network, while that portion of the neural network framework that trains and updates training of the trained neural network is implemented at the remote classification server 204 which sends updated trained neural networks to the scanning station 202 for inclusion and execution in the configuration manager 212.

In some examples, the configuration manager 212 is configured to receive object classification data from the classification server 204 and to determine configuration settings for operating the imaging assembly 208 and/or the illumination assembly 210. That is, in some examples, the configuration manager 212 make be a decision engine that additionally stores configuration settings data corresponding to different classifications, for affecting the contextual configuration settings determination.

In various examples, the configuration settings may be optical settings, such as illumination source, illumination brightness, exposure time, optical gain, indirect illumination source, direct illumination source, illumination color, and/or illumination source type. In various examples, the configuration settings may be digital imaging settings such as digital gain. In various examples, the configuration settings may be physical settings for the imaging scanner 206, such as, for example, a focal distance, selected field of view, or focal plane position on an imaging sensor. In various examples, the configuration settings are settings for operating the imaging assembly 208. In various examples, the configuration settings are settings for operating the illumination assembly 210.

In some examples, the process 306 determines configurations from a plurality of available configuration settings stored in the configuration data 264 of in the configuration manager 212. A plurality of different configuration settings may be available for a particular classification, for example, for a produce classification such as an apple (fruit) classification. Different configuration settings may include different illumination intensities, different illumination sources, different illumination wavelengths, and different fields of view (for example if the imaging scanner is a bi-optic). Some configuration settings may be settings that combine any of these settings together, i.e., the configuration settings may be multi-dimensional including settings for many different operating parameters.

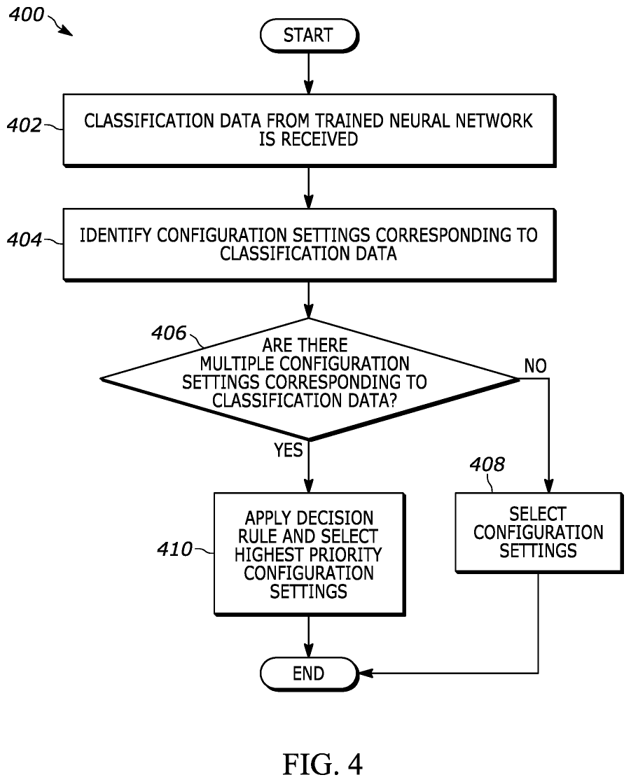

FIG. 4 illustrates an example process 400 for implementing the process 306 in FIG. 3. Classification data from the trained neural network 262 is received as a process 402. As with the process 300, any or all of the processes in the process 400 may be implemented entirely at the scanning station 202. In some examples, the trained neural network 262 may classify an object by identifying a percentage likelihood for different classes for an object. That object may be assigned a likelihood score of 0.6 for a first classification, 0.2 for a second classification, 0.1 for a third classification, and 0.1 for a fourth classification, resulting in a classification vector {0.6, 0.2, 0.1, 0.1}. The result is classification data that may include more than a single identified class. At process 404, configuration settings corresponding to the classification data are identified, for exampling using the processing platform 250 and/or the configuration manager 212. In some examples, the process 404 may identify a plurality of configuration settings corresponding to the classification data received. At a process 406, a determination is made whether there are indeed multiple different configuration settings corresponding to the classification data. If there are not multiple possible configuration settings, then control is passed to a process 408 that selects the corresponding configuration settings and the process ends, for process 308 in FIG. 3 to execute. If instead, there are multiple possible configuration settings, a process 410 may then apply a decision rule to select a highest priority configuration settings for application by the process 308. For example, the process 410 may assess whether the second classification likelihood score in the classification vector is high enough for the process 404 to identify a strongest one of the first plurality of configuration settings that would also correspond to the second classification. This is one way the process 410 may select from among the multiple corresponding configuration settings, the configuration settings that should be used to configure the imaging scanner 206.

In some examples, the process 304 determines a plurality of possible classifications for an object, such as by identifying any classification with a likelihood score above a certain amount, and sends that plurality as classification data to the process 306, for handling using the process 400 in FIG. 4, for example. In some examples, the process 304 may identify a highest priority classification from among the plurality of possible classifications, for example using a classification ranking rule or some other decision algorithm. The process 304 would then assign the object the highest priority classification; and the process 306 would determine configuration settings for the imaging scanner based on that highest priority classification.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. Method of performing contextual configuration of an imaging scanner, the method comprising:
a) identifying, at the imaging scanner, an image of an object;
b) providing the image to a trained neural network and the trained neural network classifying the object;
c) determining configuration settings for the imaging scanner based on classification of the object; and
d) configuring the imaging scanner to scan for an indicia using the configuration settings.

2. The method of claim 1, wherein the configuration settings comprise optical settings for the imaging scanner.

3. The method of claim 1, wherein optical settings comprise illumination source, illumination brightness, exposure time, optical gain, indirect illumination source, direct illumination source, illumination color, and/or illumination source type.

4. The method of claim 1, wherein the configuration settings comprise digital imaging settings for the imaging scanner.

5. The method of claim 1, wherein digital imaging settings comprise digital gain.

6. The method of claim 1, wherein the configuration settings comprise physical settings for the imaging scanner.

7. The method of claim 1, wherein physical settings comprise focal distance, field of view, and/or focal plane position of an imaging sensor.

8. The method of claim 1, wherein the trained neural network is a convolutional neural network.

9. The method of claim 1, wherein the trained neural network is trained to classify objects by object type, scanning surface of the object, reflectivity of the object, and/or type of indicia on object.

10. The method of claim 1, wherein the image is a captured image of the object, captured by the imaging scanner.

11. The method of claim 1, wherein the image is a lower resolution rendition of a captured image of the object.

12. The method of claim 1, wherein determining the configuration settings for the imaging scanner based on the classification of the object comprises selecting from a plurality of configuration settings stored on the imaging scanner.

13. The method of claim 1, wherein the trained neural network classifying the object comprises the trained neural network providing a plurality of classifications of the object, the method further comprising:
identifying a highest priority classification from the plurality of classifications;
assigning the object the highest priority classifications; and
determining the configuration settings for the imaging scanner based on the highest priority classification.

14. An imaging scanner comprising:
an imager assembly configured to capture an image of an object; and
a processor and memory storing instructions that, when executed, cause the processor to:
identify an image of an object;
provide the image to a trained neural network and classify, using the trained neural network, the object;
determine configuration settings for the imaging scanner based on classification of the object; and
configure the imaging scanner to scan for an indicia using the configuration settings.

15. The imaging scanner of claim 14, wherein the memory storing further instructions that, when executed, cause the processor to:
determine the configuration settings for the imaging scanner based on the classification of the object by selecting from a plurality of configuration settings stored on the imaging scanner.

16. The imaging scanner of claim 14, wherein the memory storing further instructions that, when executed, cause the processor to:
using the trained neural network, classify the object to have a plurality of classifications of the object:
identify a highest priority classification from the plurality of classifications;
assign the object the highest priority classifications; and
determine the configuration settings for the imaging scanner based on the highest priority classification.

17. The imaging scanner of claim 14, wherein the imaging scanner is a barcode reader.

18. The imaging scanner of claim 14, wherein the imaging scanner is a machine vision system.

19. The imaging scanner of claim 14, wherein the configuration settings comprise optical settings for the imaging scanner.

20. The imaging scanner of claim 14, wherein optical settings comprise illumination source, illumination brightness, exposure time, optical gain, indirect illumination source, direct illumination source, illumination color, and/or illumination source type.

21. The imaging scanner of claim 14, wherein the configuration settings comprise digital imaging settings for the imaging scanner.

22. The imaging scanner of claim 14, wherein digital imaging settings comprise digital gain.

23. The imaging scanner of claim 14, wherein the configuration settings comprise physical settings for the imaging scanner.

24. The imaging scanner of claim 14, wherein physical settings comprise focal distance, field of view, and/or focal plane position of an imaging sensor.

25. The imaging scanner of claim 14, wherein the trained neural network is a convolutional neural network.

26. The imaging scanner of claim 14, wherein the trained neural network is trained to classify objects by object type, scanning surface of the object, reflectivity of the object, and/or type of indicia on object.

27. The imaging scanner of claim 14, wherein the memory storing further instructions that, when executed, cause the processor to:
identify the image of the object as a captured image of the object, captured by the imaging scanner.

28. The imaging scanner of claim 14, wherein the memory storing further instructions that, when executed, cause the processor to:
identify the image of the object as a lower resolution rendition of a captured image of the object.

29. The imaging scanner of claim 14, wherein the memory storing further instructions that, when executed, cause the processor to:
identify a highest priority classification from the plurality of classifications;
assign the object the highest priority classifications; and
determine the configuration settings for the imaging scanner based on the highest priority classification.
